(19) United States
(12) Patent Application Publication
(10) Pub. No.: US 2013/0289147 A1
(43) Pub. Date: Oct. 31, 2013

(54) THERMOPLASTIC MOULDING COMPOUNDS WITH INCREASED MELT STABILITY

(71) Applicants: Günter Margraf, Dormagen (DE); Detlev Joachimi, Krefeld (DE); Maik Schulte, Hagen (DE); Richard Weider, Leverkusen (DE)

(72) Inventors: Günter Margraf, Dormagen (DE); Detlev Joachimi, Krefeld (DE); Maik Schulte, Hagen (DE); Richard Weider, Leverkusen (DE)

(73) Assignee: LANXESS DEUTSCHLAND GMBH, Leverkusen (DE)

(21) Appl. No.: 13/698,763

(22) PCT Filed: May 19, 2011
(86) PCT No.: PCT/EP2011/058215

§ 371 Date: Jul. 3, 2013

(30) Foreign Application Priority Data
May 20, 2010 (EP) 10163433.5

(51) Int. Cl. C08L 77/02

(52) U.S. Cl. CPC C08L 77/02
USPC 521/88; 525/108; 524/514; 264/523; 264/328.18; 264/176.1

(57) ABSTRACT

This invention relates to substance mixtures for thermoplastic molding compositions, comprising A) polyamide and/or copolyamide, B) copolymers of at least one olefin and of at least one acrylate of an aliphatic alcohol, C) additives with chain-extending effect and D) impact modifiers and optionally also E) other additives and/or F) fillers and reinforcing materials. The invention further relates to processes for producing molding compositions of the invention and molded products or semifinished products which are produced from the substance mixtures of the invention, preferably by means of extrusion or blow molding of the molding compositions to be produced from the substance mixtures.

This invention relates to substance mixtures for thermoplastic molding compositions, comprising A) polyamide and/or copolyamide, B) copolymers of at least one olefin and of at least one acrylate of an aliphatic alcohol, C) additives with chain-extending effect and D) impact modifiers and optionally also E) other additives and/or F) fillers and reinforcing materials. The invention further relates to processes for producing molding compositions of the invention and molded products or semifinished products which are produced from the substance mixtures of the invention, preferably by means of extrusion or blow molding of the molding compositions to be produced from the substance mixtures.

In recent years, compounded polyamide materials, e.g. those based on nylon-6 and nylon-6,6, have increasingly replaced traditional metal structures in the engine compartment of motor vehicles. The reason for this is not only the reduction of component weights and advantages in the production process (cost reduction, function integration, materials- and process-related design freedom, smoother inner surfaces, etc) but also in particular the excellent properties of the materials, for example high long-term service temperatures, high dynamic strength and resistance to heat-aging, and also very good corrosion resistance, and very good chemicals resistance with respect to oils, greases, battery acid, coolants, road salt, etc. (“Rohrsysteme im Motorraum” [Pipe systems in the engine compartment], Kunststoffe 11/2007, Carl Hanser Verlag, 126-128).

Polyamides are semicrystalline polymers with very high hydrogen bond content and therefore have low melt viscosities. Polyamides that have proven very successful for producing moldings in injection-molding processes, i.e. at shear rates from 1000 to 10 000 s⁻¹, are those with relative viscosity η rel about 3 (measured in 1% solution of polyamide in meta-kresol at 25° C.).

Components of the engine compartment, e.g. air ducts, intake pipes, intake modules, charge-air lines and clean-air lines, coolant-circuit pipes, and the like are often produced from polymeric materials by means of extrusion and blow-molding processes. A process commonly used for producing hollow bodies of this type is extrusion blow molding. The thermoplastic molding composition is melted in an extruder and then a melt tube, known as the parison, is produced within the annular gap of a crosshead die and extruded vertically downward. The shear rates during the extrusion process are <<1000 s⁻¹. As soon as the parison has reached the required length, it is received by, or introduced into, a hollow mold, which mostly has two parts. The hollow mold is closed and then the residual tube sections protruding upward and downward are pinched off by the pinch-off edges of the mold, and the melt tube is then expanded by blowing with the aid of compressed air, with use of a blowing mandrel or of an inserted pin. During this process, the tube replicates the shape of the interior of the mold. It has now become possible to produce even complex, multidimensional components by using new specialized 3D processes (3D parison manipulation, 3D suction blow molding processes) (Thielen, Hartwig, Gust, “Blasformen von Kunststoffhohlkörpern” [Blow Molding of Hollow Plastics Products], Carl Hanser Verlag, Munich 2006, pages 15 to 17 and 117 to 127).

Polyamides of moderate and normal melt viscosity, i.e. products with relative viscosity η rel≈3.0 (measured in 1% solution of polyamide in meta-kresol at 25° C.) are unsuitable for extrusion blow molding, since the extruded parisons undergo excessive lengthening under their own weight. Extrusion blow molding processes therefore require maximum melt viscosity within the range of low shear rates. Polyamides suitable for the extrusion blow molding process are accordingly either high-molecular-weight, branched, or crosslinked polyamides. The polyamides involved are generally those with non-newtonian rheology, where these exhibit a rise in melt viscosity with decreasing shear force. This phenomenon is also termed pseudoplasticity. A newtonian liquid (according to Isaac Newton) is a liquid for which shear stress τ is proportional to the rate of deformation (or more correctly shear rate) du/dy:

$$τ = η \frac{d u}{d y} ;$$

where u is the flow rate parallel to the wall and y is the spatial coordinate normal to the wall. The proportionality constant η is also termed dynamic viscosity. Examples of newtonian fluids are water, and many oils and gases. The motion of newtonian fluids is described by the Navier-Stokes equations.

Most of the liquids known from everyday life have this type of behavior. Non-newtonian fluids behave differently, an example being blood or dough, which exhibit non-proportional rheology with discontinuities.

The high melt viscosities required for extrusion or blow molding processes at shear rates <<1000 s⁻¹ can be achieved in polyamides in various ways.

A process commonly used is postcondensation in the melt and/or in the solid phase (Kunststoff-Handbuch [Plastics Handbook] 3/4, Polyamide [Polyamides], Carl Hanser Verlag, Munich 1998, pp. 45-46). However, the reaction times and/or residence times are often long and are a disadvantage of this process. EP 0315 408 A1 describes the reduction of postcondensation time for dry polyamides achieved by adding catalytic amounts of orthophosphoric acid or of phosphorous acid. However, the molecular weight declines markedly in the presence of small amounts of moisture.

It is also possible to obtain high-viscosity polyamides through use of additives that increase molecular weight, by means of reactive extrusion, where these lead to long-chain branching of the main polymer chain (Kunststoff-Handbuch 3/4, Polyamide, Carl Hanser Verlag, Munich 1998, page 289-290).

EP 0 685 528 A1 describes the use of diepoxides for producing compounded polyamide materials with increased melt viscosity. The polyamide molding compositions exhibit high viscosities, have good processability in the extrusion process and extrusion blow molding process, and have surprisingly high melt strengths. The extruded or injection-molded parts produced therefrom exhibit very good weldability in hot-plate processes, heat-sealing processes, vibration processes, or high-frequency processes.

Bislactams (WO 98/47940 A1) and mixtures of bislactams and bisoxazolines, or of bislactams and bisoxazines (WO 96/34909 A1) have likewise been used for producing polyamides with high molecular weight. The high melt viscosity makes these molding compositions particularly suitable for applications which use extrusion or blow molding to produce foils and semifinished products.

U.S. Pat. No. 4,128,599 describes a process for producing polyamides with improved melt strength and increased solution viscosity, based on aromatic polycarbodiimides, for extrusion applications.

WO 2003/074581 A1 describes a process for producing high-molecular-weight polyamides, polyesters, copolyesters, copolyamides, or polyesteramide block copolymers, by using capped diisocyanates.

DE 4 136 078 A1 describes a process for rapid production of polyamides condensed to higher molecular weight, with oligo- and/or polyurethanes.

DE 1 9920 336 A1 describes a process for condensing oligo- and/or (co)polyamides to increase molecular weight, with block copolymers of the AB type or A[BA]_{n≧1} type, where A is a polycarbonate block and B is a non-polycarbonate block. Low-viscosity polycarbonates have likewise been described for condensation to increase the molecular weight of polyamide molding compositions, in the presence (EP 1 690 890 A1) or absence of phosphorus-containing compounds which are proton acids (EP 1 690 889 A1). The low-viscosity polycarbonate used in the inventive examples here is obtainable commercially in mixtures with acid-terminated nylon-6 (PA6), as Brüggolen® M1251. The cited prior art moreover includes processes for producing moldings, in particular hollow products of large diameter, by means of extrusion, coextrusion, and blow molding.

Chain-branching agents for polyamide based on maleic anhydride copolymers have likewise been described (EP 0 495 363 A1/WO 2002/070605 A1).

However, the reactive additions mentioned are often expensive, have limited shelf life, or can cause uncontrolled crosslinking. Polycarbodiimides and isocyanates are moreover compounds which are relatively volatile and often not free from toxicological risk.

Nanoscale minerals can also be used to increase viscosity: EP 1 394 197 A1 describes high-viscosity polyamide extrusion blow molding compositions based on non-amorphous polyamides and on nanoscale phyllosilicates which are suitable for the extrusion blow molding process and also retain adequate strength at temperatures from 150 to 200° C.

Properties such as shear-rate-dependent melt viscosities are mostly of only limited use for assessment of processability by means of extrusion or blow molding. Substantially better information about practical suitability is provided by extrusion tests in which melt tubes are extruded vertically downward from an annular die under constant conditions and processing properties, such as melt strength, are determined.

Melt strength means the extent to which sag is avoided in the parison: materials with low melt strength tend to flow downward or undergo a length increase due to the effect of their own weight. This behavior is termed sagging (Technical Data Sheet “Verarbeitung von Grilamid und Grilon durch Extrusionsblasformen” [Processing of Grilamid and Grilon by Extrusion Blow Molding], 1998, EMS-GRIVORY, p. 4). Sagging results in undesired wall thickness differences between the lower and the upper region of the parison. Materials with maximum melt strength are therefore used in the extrusion blow molding process.

The literature describes various methods for evaluating melt strength:

In EP 1 394 197 A1, the molding composition to be tested is melted in a single-screw extruder and a tube is extruded with constant throughput from a vertical die. Melt strength measured in seconds here is the time required for gravity to cause the length of the tube section to increase to 1 m.

WO2001/066643 A1 evaluates melt strength by analogy with EP 1 394 197 A1: melt tubes are continuously extruded vertically downward, and the time required for the melt tube to reach a prescribed length is evaluated here. As an alternative, the material can be extruded for discrete times, and the lengthening of the tube sections can be observed as the time interval becomes longer. In both instances, the length of the tube under ideal conditions without lengthening or shrinkage provides a basis for comparison.

U.S. Pat. No. 4,128,599 defines the melt strength M_{S} as follows:

M_{S}=T₁/T₂

T₁ is the time required for continuous extrusion of the first 3 inches of a polyamide strand of length 6 inches, and T₂ is the time required for continuous extrusion of the second 3 inches of a polyamide strand of length 6 inches, under constant conditions. The extrusion process takes place with constant melt output of 0.25 inch per minute. A desirable criterion for extrusion applications is considered to be 1.0≦M_{S}≦2.0, where M_{S}=1.0 corresponds to a material for which the extrusion speed is the same for the second tube section as the first, i.e. a material which does not lengthen.

WO2006/079890 A1 evaluates melt strength SMF by using the wall thickness difference between the lower and upper region of the extruded parison, expressed by the factor f_{SMF}. As melt strength increases, the quotient f_{SMF} calculated by dividing greatest wall thickness dₘₐₓ by smallest wall thickness dₘᵢₙ approximates increasingly to the value 1.

f_{SMF}=dₘₐₓ/dₘᵢₙ

Materials for which f_{SMF}=1.0 accordingly exhibit no sagging and do not lengthen.

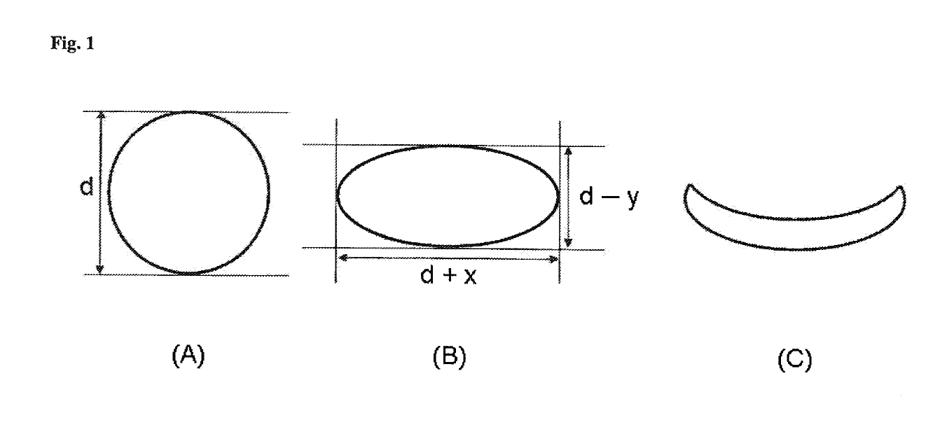

Processability by means of extrusion and blow molding requires not only high melt strength but also high resistance to collapse of the extruded parison. As an extruded parison (A) with circular cross section and with diameter d begins to solidify directly after the extrusion process, while lying horizontally on a flat, firm substrate it assumes an approximately elliptical cross section (B) with a major axis of width d+x and with a minor axis of height d−y. Collapse means the alteration of the approximately elliptical cross section to form a convex-concave cross section (C) (see in this connection FIG. 1).

The available prior art does not adequately satisfy the criterion of high resistance to collapse of the extruded parison.

Copolymers of olefins with methacrylates or acrylates can act as flow improvers in polyamide molding compositions in the injection-molding process, i.e. at shear rates from 1000 to 10 000 s⁻¹. WO2005/121249 A1 therefore says that, in the injection-molding process, mixtures of at least one semicrystalline thermoplastic polyamide with copolymers of olefins with methacrylates or acrylates of aliphatic alcohols, where the MFI of these is not less than 100 g/10 min, reduce the melt viscosity of the molding compositions of the invention produced therefrom (MFI=Melt Flow Index).

EP 1 333 060 A1 discloses polyamide molding compositions which comprise, in addition to the polyamide, fillers and reinforcing materials, di- or polyfunctional branching and/or polymer-chain-extending additives, impact modifiers, and also other non-branching and non-polymer-chain-extending additives.

The object of the present invention was to provide polyamide molding compositions which are suitable for use in extrusion and extrusion blow molding processes and which exhibit an increase of viscosity in the region of low shear rates, and exhibit increased melt strengths in the extrusion process. The object also included provision of polyamide molding compositions which give extruded parisons with high resistance to collapse.

Surprisingly, it has now been found that compounded polyamide materials with increased viscosity in the region of low shear rates can be obtained by compounding of polyamides of moderate viscosity with copolymers of at least one olefin, preferably one α-olefin, with at least one methacrylate or acrylate of an aliphatic alcohol, where the MFI (Melt Flow Index) of the copolymer is greater than 10 g/10 min, preferably greater than 150 g/10 min, and particularly preferably greater than 300 g/10 min, and epoxidized vegetable oil or other di- or polyfunctional additives with branching or chain-extending effect, and also impact modifiers and/or optionally other additives. The molding compositions of the invention exhibit increased melt strengths in the extrusion process (shear rates <<1000 s⁻¹), and the parisons extruded therefrom exhibit high resistance to collapse. It is surprising that even low-viscosity copolymers B) with a high MFI, for example an MN of 550, give a significant increase in melt strength and increased resistance to collapse of the extruded parison.

The present invention provides substance mixtures for thermoplastic molding compositions, comprising
A) from 70 to 98.99 parts by weight of polyamide,
B) from 1 to 10 parts by weight, preferably from 2 to 8 parts by weight, particularly preferably from 3 to 6 parts by weight, of a copolymer composed of at least one olefin, preferably α-olefin, and at least one methacrylate or acrylate of an aliphatic alcohol, where the MFI (Melt Flow Index) of the copolymer B) is greater than 10 g/10 min, preferably greater than 150 g/10 min, and particularly preferably greater than 300 g/10 min, and the MFI is determined or measured at 190° C. with a load of 2.16 kg,
C) from 0.01 to 10 parts by weight, preferably from 0.1 to 6 parts by weight, particularly preferably from 0.5 to 5 parts by weight, of an or additive having chain-extending effect from the group of epoxidized fatty acid esters of glycerol or of modified bisphenol A epoxy resins, and
D) from 0.001 to 40 parts by weight, preferably from 5 to 35 parts by weight, particularly preferably from 10 to 30 parts by weight, of at least one impact modifier.

For the purposes of the present invention, the total of the parts by weight is always 100 irrespective of the number of components used.

In one preferred embodiment, the substance mixtures, or the corresponding molding compositions, to be used in the invention also comprise from 0.001 to 5 parts by weight of other additives E), in addition to components A), B), C), and D).

In another preferred or alternative embodiment, the substance mixtures/molding compositions to be used in the invention can also comprise, in addition to components A), B), C), D), and E), from 0.001 to 70 parts by weight, preferably from 5 to 50 parts by weight, particularly preferably from 9 to 47 parts by weight, of at least one filler or reinforcing material.

The present invention is thus also characterized in that the substance mixtures/molding compositions of the invention optionally comprise, or else do not comprise, in addition to components A), B), C), and D), one or more components from the group of
E) from 0.001 to 5 parts by weight of other conventional additives
F) from 0.001 to 70 parts by weight of at least one filler or reinforcing material.

The application further provides a process for producing molding compositions of the invention from the substance mixtures of the invention.

The application further provides molded products and semifinished products made of the molding compositions of the invention, preferably produced by means of profile extrusion or other extrusion processes, or blow molding, of said molding compositions, where blow molding particularly preferably means standard extrusion blow molding, 3D extrusion blow molding processes, and suction blow molding processes.

Molded products to be produced in the invention are preferably
components conducting oil in motor vehicles
components conducting air in motor vehicles, with particular preference intake pipes and charge-air pipes
components conducting cooling water in motor vehicles, with particular preference cooling-system pipes and expansion tanks
pipes conducting other fluids and containers in motor vehicles
fuel tanks.

For clarification, it should be noted that the scope of the invention comprises any desired combination of all of the definitions and parameters mentioned in general terms or in preferred ranges.

There is a wide variety of known procedures for producing polyamides, using, as a function of desired final product, different monomer units, various chain-transfer agents for adjustment to a desired molecular weight, or else monomers having reactive groups for intended subsequent post-treatment processes.

Industrially relevant processes for producing the polyamides to be used in the substance mixture preferably proceed by way of polycondensation in the melt. In the invention, this polycondensation is also understood as including the hydrolytic polymerization of lactams.

Polyamides preferred in the invention are semicrystalline or amorphous polyamides which can be produced by starting from diamines and dicarboxylic acids and/or lactams having at least 5 ring members, or from appropriate amino acids. Preferred starting materials used are aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, pentamethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethyl-cyclohexane, phenylenediamines, xylylenediamines, aminocarboxylic acids, in particular aminocaproic acid, or the corresponding lactams. Copolyamides of a plurality of the monomers mentioned are included.

Particular preference is given to nylon-6, nylon-6,6, and caprolactam, as comonomer-containing copolyamides.

There can also be content of recycled polyamide molding compositions and/or of recycled fiber materials present.

The relative viscosity η rel of the polyamides to be used as main resin for the molding compositions of the invention is preferably from 2.3 to 4.0, particularly preferably from 2.7 to 3.5 (measured in a 1% by weight solution in meta-kresol at 25° C.).

The substance mixture to be used in the invention comprises copolymers B) of at least one olefin, preferably α-olefin, and of at least one methacrylate or acrylate of an aliphatic alcohol, where the MFI of the copolymer B) is greater than 10 g/10 min, preferably greater than 150 g/10 min, and particularly preferably greater than 300 g/10 min. In one preferred embodiment, the copolymer B) is composed of less than 4 parts by weight, particularly preferably less than 1.5 parts by weight, and very particularly preferably 0 parts by weight, of monomer units which comprise other reactive functional groups selected from the group consisting of epoxides, oxetanes, anhydrides, imides, aziridines, furans, acids, amines, and oxazolines.

Olefins, preferably α-olefins, suitable as constituent of the copolymers B) preferably have from 2 to 10 carbon atoms, and can be unsubstituted or can have substitution by one or more aliphatic, cycloaliphatic, or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and ethene is very particularly preferred.

Mixtures of the olefins described are likewise suitable.

In an embodiment to which further preference is given, the other reactive functional groups of the copolymer B), selected from the group consisting of epoxides, oxetanes, anhydrides, imides, aziridines, furans, acids, amines, oxazolines, are introduced exclusively by way of the olefins into the copolymer B).

The content of the olefin in the copolymer B) is from 50 to 90 parts by weight, preferably from 55 to 75 parts by weight.

The copolymer B) is further defined through the second constituent alongside the olefin. The second constituent used comprises alkyl esters or arylalkyl esters of acrylic acid, where the alkyl or arylalkyl group of these is composed of from 1 to 30 carbon atoms. The alkyl or arylalkyl group here can be a linear or branched group, and can also comprise cycloaliphatic or aromatic groups, and can also have substitution by one or more ether or thioether functions. Other acrylates suitable in this context are those synthesized from an alcohol component based on oligoethylene glycol or on oligopropylene glycol having only one hydroxy group and at most 30 carbon atoms.

The alkyl group or arylalkyl group of the acrylate can preferably be one selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl, and 1-octadecyl. Preference is given to alkyl groups or arylalkyl groups having from 6 to 20 carbon atoms. Preference is also in particular given to branched alkyl groups, where these give a lower glass transition temperature T_{G} than linear alkyl groups having the same number of carbon atoms.

Particular preference is given in the invention to copolymers B) where the olefin is copolymerized with 2-ethylhexyl acrylate. Mixtures of the acrylates described are likewise suitable.

Preference is given here to the use of more than 60 parts by weight, particularly preferably more than 90 parts by weight, and very particularly preferably 100 parts by weight, of 2-ethylhexyl acrylate, based on the total amount of acrylate in the copolymer B).

In another preferred embodiment, the other reactive functional groups selected from the group consisting of epoxides, oxetanes, anhydrides, imides, aziridines, furans, acids, amines, oxazolines in the copolymer B) are introduced exclusively by way of the acrylates into the copolymer (B).

The content of the acrylates in the copolymer B) is from 10 to 50 parts by weight, preferably from 25 to 45 parts by weight.

The substance mixture of the invention comprises, as component C), additives having chain-extending effect from the group of epoxidized fatty acid esters of glycerol or of modified bisphenol A epoxy resins.

The substance mixture of the invention particularly preferably comprises, as component C), epoxidized fatty acid esters of glycerol or bisphenol A diglycidyl ether.

The substance mixture of the invention very particularly preferably comprises epoxidized vegetable oils, with particular preference epoxidized soybean oil, epoxidized hemp oil, epoxidized rapeseed oil, epoxidized linseed oil, epoxidized corn oil, epoxidized palm oil, epoxidized sesame oil, epoxidized sunflower oil, or epoxidized wheatgerm oil, and in particular with very particular preference epoxidized soybean oil (CAS 8013-07-8).

Particular preference is given to diepoxides based on diglycidyl ether (bisphenol and epichlorohydrin), based on amine epoxy resin (aniline and epichlorohydrin), based on diglycidyl ester (cycloaliphatic dicarboxylic acids and epichlorohydrin) individually or in a mixture, and also 2,2-bis[p-hydroxyphenyl]propane diglycidyl ether, bis[p-(N-methyl-N-2,3-epoxypropylamino)phenyl]methane, and epoxidized fatty acid esters of glycerol, comprising at least two and at most 15 epoxy groups per molecule.

Epoxidized soybean oil is known as costabilizer and plasticizer for polyvinyl chloride (Plastics Additives Handbook, 5th Edition, Hanser-Verlag, Munich, 2001, pp. 460-462). It is used in particular in polyvinyl chloride capsules for metal caps for airtight closure of glass containers and bottles.

The following are particularly preferably suitable for branching/chain extension:
1. Epoxy compounds, where these preferably also derive from mononuclear phenols, in particular from resorcinol or hydroquinone; or are based on polynuclear phenols, in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulfone, or on phenol condensates obtained under acidic conditions with formaldehyde, e.g. phenol novolaks.
2. Epoxidized fatty acid esters of glycerol, in particular abovementioned epoxidized vegetable oils. They are obtained by epoxidizing the reactive olefin groups of triglycerides of unsaturated fatty acids. Epoxidized fatty acid esters of glycerol can be produced by starting from unsaturated fatty acid esters of glycerol, preferably of vegetable oils, and organic peroxycarboxide acids (Prilezhaev reaction). Processes for producing epoxidized vegetable oils are described by way of example in Smith, March, March's Advanced Organic Chemistry (5th edition, Wiley-Interscience, New York, 2001). Preferred epoxidized fatty acid esters of glycerol are vegetable oils. Epoxidized soybean oil (CAS 8013-07-8) is particularly preferred epoxidized fatty acid ester of glycerol in the invention.

Impact modifiers D) are also often termed elastomer modifiers, elastomer, modifier, or rubber.

These preferably comprise copolymers, with the exception of copolyamides, where these are preferably composed of at least two monomers from the group of ethylene, propylene, butadiene, isobutene, isoprene, chloroprene, vinyl acetate, styrene, acrylonitrile and acrylates and methacrylates having from 1 to 18 carbon atoms in the alcohol component.

Polymers of this type are described by way of example in Houben-Weyl “Methoden der organischen Chemie” [Methods of organic chemistry], Volume 14/1 (Georg-Thieme-Verlag, Stuttgart, 1961), pp. 392 to 406 and in Monographie by C. B. Bucknall, “Toughened Plastics” (Applied Science Publishers, London, 1977).

Some impact modifiers to be used with preference according to the present invention are described below.

Preferred types of these elastomers to be used as impact modifiers are those known as ethylene-propylene rubbers (EPM) or ethylene-propylene-diene (EPDM) rubbers.

EPM rubbers generally have practically no residual double bonds, whereas EPDM rubbers can have from 1 to 20 double bonds per 100 carbon atoms.

Preferred diene monomers used for EPDM rubbers are conjugated dienes such as isoprene or butadiene, non-conjugated dienes having from 5 to 25 carbon atoms, e.g. penta-1,4-diene, hexa-1,4-diene, hexa-1,5-diene, 2,5-dimethylhexa-1,5-diene and octa-1,4-diene, cyclic dienes such as cyclopentadiene, cyclohexadiene, cyclooctadiene and dicyclopentadiene, and also alkenylnorbornenes, such as 5-ethylidene-2-norbornene, 5-butylidene-2-norbornene, 2-methallyl-5-norbornene, 2-isopropenyl-5-norbornene and tricyclodienes such as 3-methyltricyclo[5.2.1.0^{2,6}]-3,8-decadiene or a mixture of these. Particular preference is given to hexa-1,5-diene, 5-ethylidenenorbornene or dicyclopentadiene. The diene content of the EPDM rubbers is preferably from 0.5 to 50, in particular from 1 to 8% by weight, based on the total weight of the rubber.

EPM rubbers or EPDM rubbers can preferably also have been grafted with reactive carboxylic acids or with derivatives of these. The following may be mentioned here with preference: acrylic acid, methacrylic acid or derivatives of these, in particular glycidyl (meth)acrylate, and also maleic anhydride.

Copolymers of ethylene with acrylic acid and/or methacrylic acid are a further group of preferred rubbers. The rubbers can also comprise dicarboxylic acids, preferably maleic acid or fumaric acid or derivatives of the said acids, preferably esters and anhydrides, and/or monomers comprising epoxy groups. These dicarboxylic acid derivatives or monomers comprising epoxy groups are preferably incorporated into the rubber via addition, to the monomer mixture, of monomers of the general formulae (I) or (II) or (III) or (IV), where these comprise dicarboxylic acid groups and, respectively, epoxy groups,

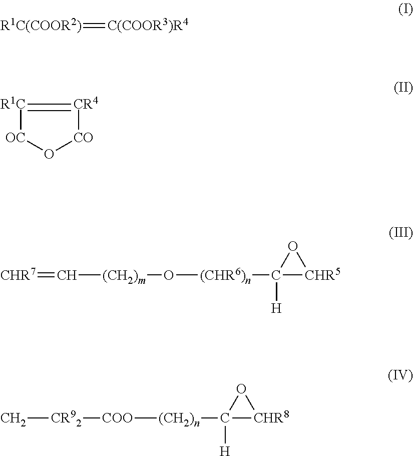

in which
R¹ to R⁹ are hydrogen or alkyl groups having from 1 to 6 carbon atoms,
m is an integer from 0 to 20, and
n is an integer from 0 to 10.

The moieties R¹ to R⁹ are preferably hydrogen, where m is 0 or 1 and n is 1. The corresponding compounds are maleic acid, fumaric acid, maleic anhydride, allyl glycidyl ether and vinyl glycidyl ether.

According to the invention, preferred compounds of the formulae (I), (II) and (IV) are maleic acid and maleic anhydride, glycidyl acrylate, glycidyl methacrylate, and the esters with tertiary alcohols, preferably tert-butyl acrylate. Although the latter have no free carboxy groups, their behavior approximates to that of the free acids, and they are therefore termed monomers having latent carboxy groups.

The copolymers are preferably composed of from 50 to 98 parts by weight of ethylene, and from 0.1 to 20 parts by weight of monomers comprising epoxy groups and/or monomers comprising anhydride groups.

It is also possible to use vinyl esters and vinyl ethers as other comonomers.

The ethylene copolymers described above can be produced by processes known per se, preferably via random copolymerization under high pressure and at elevated temperature. Corresponding processes are well known.

Other preferred elastomers are emulsion polymers, where the production of these is described by way of example in the monograph “Emulsion Polymerization” by Blackley. The emulsifiers and catalysts that can be used are known per se.

In principle, it is possible to use elastomers of homogenous structure or else those having a shell structure. The shell-type structure is determined via the sequence of addition of the individual monomers; this sequence of addition also affects the morphology of the polymers.

Acrylates, preferably n-butyl acrylate and 2-ethylhexyl acrylate, corresponding methacrylates, butadiene, and isoprene, and also mixtures of these, may be mentioned here merely as representatives of monomers for producing the rubber portion of the elastomers. The said monomers can be copolymerized with other monomers from the group consisting of styrene, acrylonitrile, and vinyl ethers.

The soft phase or rubber phase of the elastomers, preferably with glass transition temperature below 0° C., can be the core, the outer envelope or an intermediate shell, in particular in the case of elastomers having a structure comprising more than two shells; in multishell elastomers it is also possible that a plurality of shells are composed of a rubber phase.

If the structure of the elastomer involves not only the rubber phase but also one or more hard components, preferably with glass transition temperatures above 20° C., these are generally produced via polymerization of styrene, acrylonitrile, methacrylonitrile, α-methylstyrene, p-methylstyrene, acrylic esters and methacrylic esters such as methyl acrylate, ethyl acrylate, and methyl methacrylate as main monomers. It is also possible here to use relatively small proportions of other comonomers, alongside these.

In some instances it has proved advantageous to use emulsion polymers which have reactive groups at the surface. Groups of this type are preferably epoxy, carboxy, latent carboxy, amino or amide groups, or else functional groups which can be introduced via concomitant use of monomers of the general formula (V)

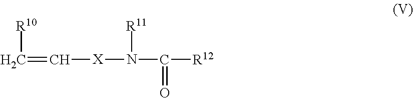

in which the definitions of the substituents can be as follows:
R¹⁰ hydrogen or a C₁-C₄-alkyl group,
R¹¹ hydrogen, a C₁-C₈-alkyl group or an aryl group, in particular phenyl,
R¹² hydrogen, a C₁-C₁₀-alkyl group, a C₆-C₁₂-aryl group or —OR¹³,
R¹³ a C₁-C₈-alkyl group or C₆-C₁₂-aryl group, which can optionally have substitution by O- or N-containing groups,
X a chemical bond, a C₁-C₁₀-alkylene group, a C₆-C₁₂-arylene group or

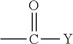

### Y O—Z or NH—Z and

Z a C₁-C₁₀-alkylene group, or a C₆-C₁₂-arylene group.

The graft monomers described in EP 0 208 187 A2 are also suitable for introducing reactive groups at the surface.

Other examples that may be mentioned are acrylamide and methacrylamide, and substituted esters of acrylic acid or methacrylic acid such as N-tert-butylaminoethyl methacrylate, N,N-dimethylaminoethyl acrylate, N,N-dimethylaminomethyl acrylate or N,N-diethylaminoethyl acrylate.

The particles of the rubber phase can moreover also have been crosslinked. Preferred monomers used as crosslinking agents are buta-1,3-diene, divinylbenzene, diallyl phthalate and dihydro-dicyclopentadienyl acrylate, and also the compounds described in EP 0 050 265 A1.

It is also possible to use the compounds known as graftlinking monomers, i.e. monomers having two or more polymerizable double bonds, where these react at different rates during the polymerization reaction. It is preferable to use compounds of this type in which at least one reactive group polymerizes at about the same rate as the other monomers, whereas the other reactive group(s) polymerize(s) by way of example markedly more slowly. The different polymerization rates give rise to a certain proportion of unsaturated double bonds in the rubber. If another phase is then grafted onto this type of rubber, at least some of the double bonds present in the rubber react with the graft monomers to form chemical bonds, i.e. there is at least some chemical bonding linking the grafted-on phase to the graft base.

Preferred graftlinking monomers are monomers comprising allyl groups, particularly preferably allyl esters of ethylenically unsaturated carboxylic acids, particularly preferably allyl acrylate, allyl methacrylate, diallyl maleate, diallyl fumarate, diallyl itaconate or the corresponding monoallyl compounds of the said dicarboxylic acids. Alongside these, there is a wide variety of other suitable graftlinking monomers; reference may be made here by way of example to U.S. Pat. No. 4,148,846 and U.S. Pat. No. 4,327,201 for further details.

Some emulsion polymers preferred according to the invention are listed below. Mention may first be made here of graft polymers having a core and at least one outer shell and having the following structure:

TABLE 1

| Type | Monomers for the core | Monomers for the envelope |
|---|---|---|
| I | Buta-1,3-diene, isoprene, | Styrene, acrylonitrile, methyl |
| | styrene, acrylonitrile, | methacrylate |
| | methyl methacrylate, | |
| | n-butyl acrylate, ethyl- | |
| | hexyl acrylate, or a | |
| | mixture of these | |
| II | as I, but with concomitant | as I |
| | use of crosslinking agents | |
| III | as I or II | n-Butyl acrylate, ethyl acrylate, |
| | | methylacrylate, buta-1,3-diene, |
| | | isoprene, ethylhexyl acrylate |
| IV | as I or II | as I or III, but with concomitant |
| | | use of monomers having reactive |
| | | groups as described herein |
| V | Styrene, acrylonitrile, | first envelope made of monomers as |
| | methyl methacrylate or a | described in I and II for the core |
| | mixture of these | second envelope as described in I |
| | | or IV for the envelope |

Instead of graft polymers having a multishell structure, it is also possible to use homogeneous, i.e. single-shell, elastomers made of buta-1,3-diene, of isoprene, and of n-butyl acrylate or of copolymers of these. Again, these products can be produced via concomitant use of crosslinking monomers or of monomers having reactive groups.

Examples of preferred emulsion polymers are n-butyl acrylate/(meth)acrylic acid copolymers, n-butyl acrylate/glycidyl acrylate copolymers or n-butyl acrylate/glycidyl methacrylate copolymers, graft polymers having an interior core made of n-butyl acrylate or based on butadiene and having an exterior envelope made of the abovementioned copolymers with comonomers that provide reactive groups.

The elastomers described can also be produced by other conventional processes, preferably via suspension polymerization. Preference is likewise given to silicone rubbers as described in DE 3 725 576 A1, EP 0 235 690 A2, DE 3 800 603 A1 and EP 0 319 290 A1.

It is also possible, of course, to use mixtures of the types of rubber listed above.

Impact modifiers of the EPM type, EPDM type, and acrylate type are used with particular preference in the invention as component D).

Preferred additives E) for the purposes of the present invention are stabilizers, antistatic agents, flow aids, mold-release agents, fire-protection additives, emulsifiers, nucleating agents, plasticizers, lubricants, dyes, pigments, branching agents, chain extenders differing from component C), or additives for increasing electrical conductivity values. The additives mentioned, and other suitable additives, are described by way of example in Gächter, Müller, Kunststoff-Additive [Plastics Additives], 3rd edition, Hanser-Verlag, Munich, Vienna, 1989, and in the Plastics Additives Handbook, 5th Edition, Hanser-Verlag, Munich, 2001. The additives can be used alone or in a mixture and/or in the form of masterbatches.

Preferred stabilizers are heat stabilizers and UV stabilizers. Preferred stabilizers used are copper halides, preferably chlorides, bromides, and iodides in conjunction with halides of alkali metals, preferably halides of sodium, of potassium and/or of lithium, and/or in conjunction with hypophosphorous acid or of an alkali metal hypophosphite or alkaline earth metal hypophosphite, and also sterically hindered phenols, hydroquinones, phosphites, aromatic secondary amines, such as diphenylamines, substituted resorcinols, salicylates, benzotriazoles or benzophenones, and also variously substituted representatives of these groups or a mixture of these.

Particularly preferred stabilizers are mixtures made of a copper iodide, of one or more halogen compounds, preferably sodium iodide or potassium iodide, or of hypophosphorous acid or of an alkali metal hypophosphite or alkaline earth metal hypophosphite, where the individual components of the stabilizer mixture added are such that the molar amount of halogen present in the molding composition is greater than or equal to six times the molar amount and less than or equal to fifteen times, preferably twelve times, the molar amounts of copper present in the molding composition, and the molar amount of phosphorus is greater than or equal to the molar amount of copper present in the molding composition and less than or equal to ten times, preferably five times, the molar amount of copper present in the molding composition.

Pigments and dyes that can preferably be used are titanium dioxide, ultramarine blue, iron oxide, carbon black, phthalocyanines, quinacridones, perylenes, nigrosin, and anthraquinones.

Nucleating agents that can preferably be used are sodium phenylphosphinate or calcium phenylphosphinate, aluminum oxide, silicon dioxide, and also preferably talc powder.

Lubricants and mold-release agents that can preferably be used are ester waxes, pentaerythritol tetrastearate (PETS), long-chain fatty acids, preferably stearic acid or behenic acid and esters, the salts thereof, preferably Ca stearate or Zn stearate, and also amide derivatives, preferably ethylenebisstearylamide or montan waxes, and preferably mixtures made of straight-chain, saturated carboxylic acids having chain lengths of from 28 to 32 carbon atoms, and also low-molecular-weight polyethylene waxes and low-molecular-weight polypropylene waxes.

Plasticizets that can be used are preferably dioctyl phthalate, dibenzyl phthalate, butyl benzyl phthalate, hydrocarbon oils, and N-(n-butyl)benzenesulfonamide.

Additives that can be added to increase electrical conductivity are preferably conductive or other carbon blacks, carbon fibrils, nanoscale graphite fibers and nanoscale carbon fibers, graphite, conductive polymers, metal fibers, and also other conventional additives for increasing electrical conductivity. Nanoscale fibers that can be used are preferably those known as “single-wall carbon nanotubes” or “multiwall carbon nanotubes”.

If component F) is used, the substance mixtures to be used in the invention can comprise from 0.001 to 70 parts by weight, preferably from 5 to 50 parts by weight, particularly preferably from 9 to 47 parts by weight, of at least one filler or reinforcing material.

The filler or reinforcing material used can, however, also comprise mixtures composed of two or more different fillers and/or reinforcing materials, for example based on talc, mica, silicate, quartz, titanium dioxide, wollastonite, kaolin, amorphous silica, magnesium carbonate, chalk, felt spar, barium sulfate, glass beads, and/or fibrous fillers, and/or reinforcing materials based on carbon fibers and/or glass fibers. It is preferable to use particulate mineral fillers based on talc, mica, silicate, quartz, titanium dioxide, wollastonite, kaolin, amorphous silicas, magnesium carbonate, chalk, felt spar, barium sulfate, and/or glass fibers.

It is particularly preferable to use particulate mineral fillers based on talc, wollastonite, kaolin, and/or glass fibers.

It is moreover also particularly preferable to use acicular mineral fillers. In the invention, acicular mineral fillers are a mineral filler with pronounced acicular character. Acicular wollastonites may be mentioned as an example. The length:diameter ratio of the material is preferably from 2:1 to 35:1, particularly preferably from 3:1 to 19:1, with particular preference from 4:1 to 12:1. The average particle size of the acicular minerals of the invention is preferably smaller than 20 μm, particularly preferably smaller than 15 μm, with particular preference smaller than 10 μm, determined with a CILAS GRANULOMETER.

As described above, the filler and/or reinforcing material can optionally have been surface-modified, for example with a coupling agent or coupling agent system, preferably based on silane. However, the pretreatment is not necessarily essential. In particular when glass fibers are used, it is also possible to use the following in addition to silanes: polymer dispersions, film-formers, branching agents, and/or glass-fiber-processing aids.

The form in which the glass fibers to be used particularly preferably in the invention, where the diameter of these is generally from 6 to 18 μm, preferably from 9 to 15 μm, are added is that of continuous-filament fibers or that of chopped or ground glass fibers. The fibers can have been equipped with a suitable size system, comprising inter alia preferably coupling agents in particular based on silane.

Silane-based coupling agents commonly used for the pretreatment are silane compounds by way of example of the general formula (VI)

(X—(CH₂)_{q})ₖ—Si—(O—CᵣH2ᵣ₊₁)₄₋ₖ (VI)

in which the definitions of the substituents are as follows:

### X is NH₂—, HO—, or

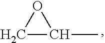

q is an integer from 2 to 10, preferably from 3 to 4,
r is an integer from 1 to 5, preferably from 1 to 2, and
k is an integer from 1 to 3, preferably 1.

Preferred coupling agents are silane compounds from the group of aminopropyltrimethoxysilane, aminobutyltrimethoxysilane, aminopropyltriethoxysilane, aminobutyltriethoxysilane, and also the corresponding silanes which comprise a glycidyl group as substituent X.

The fillers are preferably modified by using amounts which are generally from 0.05 to 2% by weight of silane compounds, preferably from 0.25 to 1.5% by weight, and in particular from 0.5 to 1% by weight, based on the mineral filler, for the surface-coating process.

As a result of the processing of the substance mixture to give the molding composition or molded product, the d97 and/or d50 value of the particulate fillers in the molding composition and/or in the molded product can be smaller than that of the fillers originally used. As a result of processing of the substance mixtures to give the molding composition and/or molded product, the length distributions of the glass fibers can be shorter in the molding composition and/or in the molded product than those originally used.

The substance mixtures of the invention and/or the molding compositions to be produced therefrom can moreover comprise constituents which have one or more dimensions smaller than 100 nanometers. These can be organic or inorganic, natural or synthetic, and it is also possible to use combinations of various nanomaterials. The substance mixtures of the invention are further processed by compounding to give thermoplastic molding compositions in granule form. The compounding process for thermoplastics is prior art (Michaeli, Einführung in die Kunststoffverarbeitung [Introduction to Plastics Processing], Carl Hanser Verlag 2010, pp. 79-86). Said molding compositions in granule form are then further processed in the invention by profile extrusion or other extrusion processes, blow molding, or injection molding, to give profiles or moldings.

The present application also provides the use, in granule form, of the molding compositions to be produced in the invention from the substance mixtures, in profile extrusion or other extrusion processes, or the blow molding process, or in the injection-molding process, for producing profiles or moldings.

Processes of the invention for producing moldings by profile extrusion or other extrusion processes, blow molding, or injection molding operate at melt temperatures in the range from 230 to 330° C., preferably from 250 to 300° C., and also optionally at pressures of at most 2500 bar, preferably at pressures of at most 2000 bar, particularly preferably at pressures of at most 1500 bar, and very particularly preferably at pressures of at most 750 bar.

For the purposes of the present invention, profiles are components or, respectively, parts which have an identical cross section over their entire length. They can be produced by the profile extrusion process. The fundamental steps of the profile extrusion process are:
1. Plastifying and providing the thermoplastic melt in an extruder,
2. extrusion of the thermoplastic melt strand through a calibrator which has the cross section of the profile to be extruded,
3. cooling the extruded profile on a calibrating table,
4. transporting the profile onward by using a take-off downstream of the calibrating table,
5. cutting the previously continuous profile to length in a cutter system,
6. collecting the cut-to-length profiles on a collection table.

The profile extrusion process for nylon-6 and nylon-6,6 is described in Kunststoff-Handbuch [Plastics Handbook] 3/4, Polyamide [Polyamides], Carl Hanser Verlag, Munich, 1998, pp. 374-384.

For the pin-poses of the present invention, blow molding processes are preferably standard extrusion blow molding, 3D extrusion blow molding, suction blow molding processes, and sequential coextrusion.

The fundamental steps of standard extrusion blow molding are (Thielen, Hartwig, Gust, “Blasformen von Kunststoffhohlkörpern” [Blow Molding of Plastics], Carl Hanser Verlag, Munich, 2006, pp. 15 to 17):
1. Plastifying and providing the thermoplastic melt in an extruder,
2. deflecting the melt to flow vertically downward and shaping of a tubular melt “parison”,
3. using a mold, the blow mold, generally composed of two half shells, to enclose the parison, freely suspended below the head,
4. inserting a blowing mandrel or one (or more) blowing pin(s),
5. blowing of the plastic parison onto the cooled wall of the blow mold, where the plastic cools and hardens, and assumes the final shape of the molding,
6. opening the mold and demolding the blow-molded part,
7. removing the pinched-off “flash” waste at both ends of the blow molding.

Other downstream operations can follow.

Standard extrusion blow molding can also be used to produce components with complex geometry and multiaxial curvature. However, the resultant moldings then comprise a high proportion of excess, pinched-off material, and have large regions with a pinch-off weld.

In order to avoid pinch-off welds and to reduce materials usage, 3D extrusion blow molding, also termed 3D blow molding, therefore uses specific devices to deform and manipulate a parison with diameter appropriately adapted to the cross section of the item, and then introduces this directly into the cavity of the blow mold. The extent of the remaining pinch-off edge is therefore reduced to a minimum at the ends of the item (Thielen, Hartwig, Gust, “Blasformen von Kunststoff-hohlkörpern” [Blow Molding of Plastics], Carl Hanser Verlag, Munich, 2006, pp. 117-122).

In the suction blow molding process, also termed the suction blowing process, the parison is conveyed directly from the tubular die head into the closed blow mold and is “sucked” through the blow mold by way of an air stream. Once the lower end of the parison emerges from the blow mold, clamping elements are used to pinch off the upper and lower ends of the parison, and the blowing and cooling procedure then follows (Thielen, Hartwig, Gust, “Blasformen von Kunststoff-hohlkörpern” [Blow Molding of Plastics], Carl Hanser Verlag, Munich, 2006, page 123).

In sequential coextrusion, two different materials are extruded in alternating sequence. The result is a parison with sections of different materials constitution in the direction of extrusion. By selecting appropriate materials it is possible to equip particular sections of the item with specifically required properties, for example for items with soft ends and hard central section or with integrated soft bellows regions (Thielen, Hartwig, Gust, “Blasformen von Kunststoffhohlkörpern” [Blow Molding of Plastics], Carl Hanser Verlag, Munich, 2006, pp. 127-129).

A feature of the injection-molding process is that the raw material, preferably in granule form, is melted (plastified) in a heated cylindrical cavity and is injected in the form of injection-molding composition under pressure within a temperature-controlled cavity. Once the composition has cooled (solidified), the injection molding is demolded.

The various phases are

1. plastifying/melting
2. injection phase (charging procedure)
3. hold-pressure phase (to take account of thermal contraction during crystallization)
4. demolding.

An injection-molding machine is composed of a clamping unit, the injection unit, the drive and the control system. The clamping unit has fixed and movable platens for the mold, an end platen, and also tie bars and drive for the movable mold platen (toggle assembly or hydraulic clamping unit).

An injection unit encompasses the electrically heatable cylinder, the screw drive (motor, gearbox) and the hydraulic system for displacing the screw and injection unit. The function of the injection unit consists in melting, metering and injecting the powder or the pellets and applying hold pressure thereto (owing to contraction). The problem of reverse flow of the melt within the screw (leakage flow) is solved via non-return valves.

Within the injection mold, the inflowing melt is then separated and cooled, and the required component is thus manufactured. Two mold halves are always needed for this process. A distinction is made between the following functional systems within the injection-molding process:
runner system
shaping inserts
venting
force-absorption system at end of machine
demolding system and transmission of movement
temperature control.

In contrast to injection molding, in extrusion the extruder, which is a machine for producing shaped thermoplastics, uses a continuous plastics extrudate, in this case a polyamide. A distinction is made between

single-screw extruders and twin-screw extruders, and also the respective subgroups of conventional single-screw extruders, conveying single-screw extruders,
contrarotating twin-screw extruders and corotating twin-screw extruders.

Extrusion plants are composed of extruder, die, downstream equipment and extrusion blow molds. Extrusion plants for producing profiles are composed of: extruder, profile die, calibrator, cooling section, caterpillar take-off and roller take-off, separation device and tilting chute.

The present invention therefore also provides moldings, molded products, or semifinished products obtainable by profile extrusion or other extrusion processes, blow molding, particularly preferably standard extrusion blow molding, 3D extrusion blow molding processes, suction blow molding processes, and sequential coextrusion, or injection molding, from the molding compositions of the invention.

However, the present invention also provides the use of moldings, of molded products, or of semifinished products obtainable by profile extrusion or other extrusion processes, blow molding, or injection molding, in the motor-vehicle, electrical, electronics, telecommunications, or computer industry, iii sports, in medicine, in the domestic sector, or in the construction industry or in the entertainment industry.

The present invention preferably provides the use of the moldings, molded products, or semifinished products produced by profile extrusion or other extrusion processes, blow molding, or injection molding for components conducting air in motor vehicles, in particular air ducts, intake pipes, intake modules, charge-air lines and clean-air lines, components conducting cooling water in motor vehicles, in particular cooling-water pipes and expansion tanks, components conducting oil in motor vehicles, pipes conducting other fluids and containers in motor vehicles, fuel tanks, and also oil tanks.

In order to provide evidence of the improvements described in the invention, appropriate plastics molding compositions were first manufactured by compounding. The individual components were mixed at temperatures from 280 to 320° C. in a twin-screw extruder (ZSK 26 Mega Compounder from Coperion Werner & Pfleiderer, Stuttgart, Germany), discharged in the form of strand in a water bath, cooled until pelletizable, and pelletized.

After drying in a pneumatic dryer (110° C., 3 hours) and quantitative determination of water content by Karl-Fischer titration, shear-rate-dependent melt viscosities were determined in a Physica MCR 300 plate-on-plate rheometer at 280° C., and extrusion tests were carried out to assess melt strength. The molding compositions of the invention were processed by means of extrusion at temperatures from 260 to 300° C.: parisons were extruded at constant throughput of 19.5 kg/h. Tubes were extruded in an E45ST3 single-screw extruder from Stork: screw diameter 45 mm, length 25D, side-fed die, mandrel/die diameter 40/44 mm.

The heating zone settings selected were as follows:

### Extruder: 50° C./230° C./250° C./250° C./250° C.

### Flange: 245° C.

### Side-fed die: 245° C./245° C./245° C.

### EXAMPLES

The screw rotation rate was adjusted, depending on the material, from 53 to 60 min⁻¹ in order to achieve a throughput of about 19.5 kg/h. Residual water content during processing was 0.01% for inventive example 1, 0.02% for inventive example 2, 0.01% for inventive example 3 and 0.002% for comparative example 1.

Table 2 and diagram 1 show the solution of the invention.

TABLE 2
Examples

| | | Exam- | Exam- | Exam- | Comparative |
|---|---|---|---|---|---|
| | | ple 1 | ple 2 | ple 3 | example 1 |
| Copolyamide ^{1a)} | [%] | | 59.4 | 61.4 | |
| Nylon-6 ^{1b)} | [%] | 61.89 | | | 66.89 |
| Ethylene-acrylate | [%] | 5 | 5 | 4 | |
| copolymer ²⁾ | | | | | |
| Epoxidized | [%] | | 3 | 2 | |
| soybean oil ³⁾ | | | | | |
| Impact modifier ⁴⁾ | [%] | 30 | 30 | 30 | 30 |
| Branching agent ⁵⁾ | [%] | 0.51 | | | 0.51 |
| Additives ⁶⁾ | [%] | 2.6 | 2.6 | 2.6 | 2.6 |
| Melt strength ⁷⁾ | [s] | 83 | 85 | 81 | 68 |
| Actual melt | [° C.] | 282 | 280 | 280 | 279 |
| temperature | | | | | |
| Pressure in | [bar] | 86 | 85 | 81 | 85 |
| side-fed die | | | | | |
| Resistance to | | 2 | 2 | 2 | 4 |
| collapse of | | | | | |
| extruded parison ⁸⁾ | | | | | |

^{1a)} PA 6/66 copolyamide (polymerized from 95% of caprolactam and 5% of AH salt made of adipic acid and hexamethylenediamine) with relative viscosity η rel from 2.85-3.05, measured in 1% by weight solution in meta-kresol at 25° C.
^{1b)} Nylon-6 with relative viscosity η rel from 2.85-3.05, measured in 1% by weight solution in meta-kresol at 25° C.
²⁾ Copolymer of ethene and 2-ethylhexyl acrylate with 63% by weight ethene content and MFI 550
³⁾ Corresponds to CAS 8013-07-8
⁴⁾ Maleic-anhydride-modified ethylene/propylene copolymer
⁵⁾ Modified bisphenol A epoxy resin
⁶⁾ Other additives, such as colorants, stabilizers, mold-release agents
⁷⁾ By analogy with EP1394197 A1, melt strength corresponds to the time in seconds which the tube extruded at constant throughput through the side-fed die required to travel the distance of 151 cm from the die to the floor.
⁸⁾ Parisons were extruded vertically under the conditions mentioned, and once these had reached a length of 50 cm they were cut off by a shearing arrangement at the side-fed die, and stored horizontally. After the parisons had been stored for one hour, they were separated at the center by a bandsaw. Collapse of the parison was assessed quantitatively on the basis of the cross section, and evaluated in a grade system (grade 1: no collapse; grade 6: very pronounced collapse).

The table below states the amounts of the starting materials in parts by weight and the effects of the invention.

The molding compositions of inventive examples 1, 2 and 3 exhibit markedly higher melt strength than comparative example 1 (by analogy with EP 0 685 528 A1). Despite the slightly higher residual water content, the extruded tubes of inventive examples 1, 2, and 3 required respectively 15, 17, and 13 seconds longer than the extruded tube of comparative example 1 in order to travel the distance of 151 cm between the die and the floor. It is notable that, despite the markedly increased melt stiffness, the pressure in the side-fed die in inventive example 3 is lower and in inventive examples 1 and 2 is comparable with that of comparative example 1.

The extruded parisons of inventive examples 1, 2 and 3 exhibit high resistance to collapse. When stored horizontally immediately after extrusion, they develop an elliptical cross section (B) as in FIG. 1. In contrast to this, an extruded parison from comparison 1 exhibits marked collapse, developing a convex-concave cross section (C) as in FIG. 1.

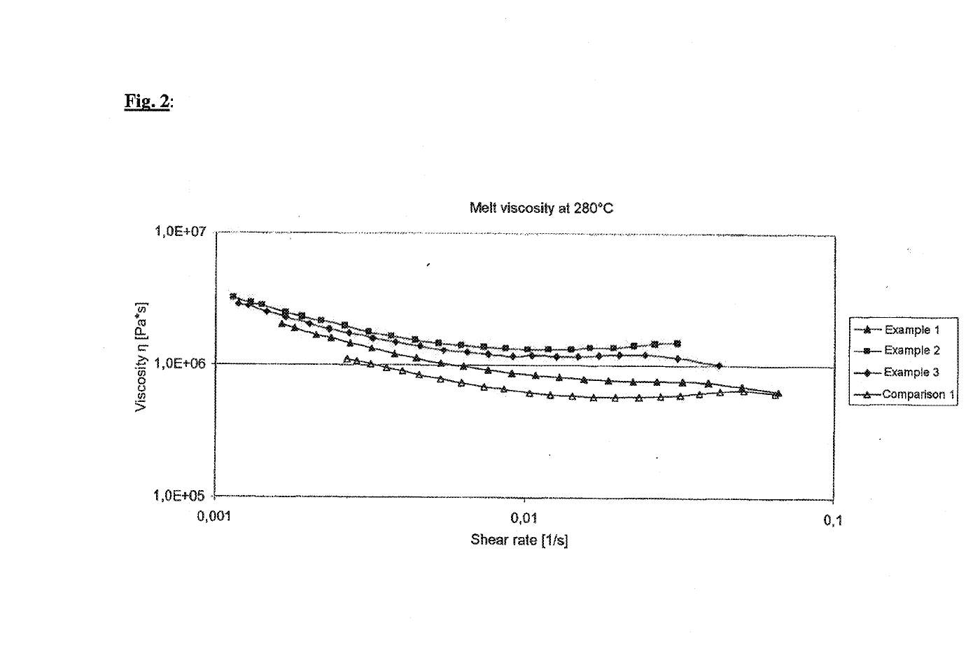

FIG. 2 shows the melt viscosity study at 280° C.

The molding compositions of inventive examples 1, 2 and 3 exhibit higher melt viscosities than comparative formulation 1.

What is claimed is:

1. A substance mixture comprising
A) from 70 to 98.99 parts by weight of polyamide,
B) from 1 to 10% by weight of a copolymer composed of at least one olefin, preferably α-olefin, and at least one methacrylate or acrylate of an aliphatic alcohol, where the MFI (Melt Flow Index) of the copolymer B) is greater than 10 g/10 min, and the MFI is determined or measured at 190° C. with a load of 2.16 kg,
C) from 0.01 to 10 parts by weight of an additive having chain-extending effect from the group of epoxidized fatty acid esters of glycerol or of modified bisphenol A epoxy resins, and
D) from 0.001 to 40 parts by weight of an impact modifier.

2. The substance mixture as claimed in claim 1, characterized in that the copolymer B) is composed of less than 4 parts by weight of monomer units which comprise other reactive functional groups selected from the group consisting of epoxides, oxetanes, anhydrides, imides, aziridines, furans, acids, amines, and oxazolines.

3. The substance mixture as claimed in claim 1 or 2, characterized in that in the copolymer B) the olefin is copolymerized with 2-ethylhexyl acrylate.

4. The substance mixture as claimed in claim 3, characterized in that in the copolymer B) the olefin is ethene.

5. The substance mixture as claimed in claims 1 to 4, characterized in that the MFI of the copolymer B) is not less than 150 g/10 min.

6. The substance mixture as claimed in claims 1 to 5, characterized in that the amount of component C) present is from 0.1 to 6 parts by weight.

7. The substance mixture as claimed in claims 1 to 6, characterized in that additive C) used with chain-extending effect comprises epoxidized vegetable oil.

8. The substance mixture as claimed in claim 7, characterized in that epoxidized soybean oil is used.

9. The substance mixture as claimed in claims 1-8, characterized in that this optionally comprises, in addition to A), B), C), and D), one or more components from the group of
E) from 0.001 to 5 parts by weight of other conventional additives
F) from 0.001 to 70 parts by weight of at least one filler or reinforcing material.

10. A process for producing blow moldings with use of the substance mixtures as claimed in claims 1-9.

11. Use of the substance mixtures as claimed in claims 1 to 9 as thermoplastic molding compositions.

12. Use as claimed in claim 11, characterized in that the thermoplastic molding compositions are used for producing moldings, molded products or semifinished products in the motor-vehicle, electrical, electronics, telecommunications, or computer industry, in sports, in medicine, in the domestic sector, or in the construction industry or in the entertainment industry.

13. The use as claimed in claim 12, characterized in that the moldings, molded products or semifinished products are used as components conducting air in motor vehicles, components conducting cooling water in motor vehicles, components conducting oil in motor vehicles, pipes conducting other fluids and containers in motor vehicles, fuel tanks or oil tanks.

14. A molding, molded product or semifinished products obtainable by profile extrusion or other extrusion processes, blow molding, or injection molding of the substance mixtures as claimed in claims 1 to 9, to be used as thermoplastic molding compositions.
